(19) United States
(12) Patent Application Publication
(10) Pub. No.: US 2008/0020837 A1
(43) Pub. Date: Jan. 24, 2008

(54) Presenting Media In A Gaming Device

(76) Inventors: Alfred Thomas, Las Vegas, NV (US); James J. Poole, Buckinghamshire (GB)

Correspondence Address: SCHWEGMAN, LUNDBERG & WOESSNER/WMS GAMING, P.O. BOX 2938, MINNEAPOLIS, MN, 55402, US

(21) Appl. No.: 11/568,664

(22) PCT Filed: Apr. 28, 2005
(86) PCT No.: PCT/US05/14672

§ 371 Date: Jun. 11, 2007

Related U.S. Application Data
(60) Provisional application No. 60/567,731, filed on May 3, 2004.

(51) Int. Cl. A63F 13/00; G06F 17/00

(52) U.S. Cl. 463/31; 463/30

(57) ABSTRACT

A method and apparatus for presenting media in a gaming device are described herein. In one embodiment, the method includes selecting a pre-recorded media segment from a set of pre-recorded media segments, wherein the selecting is performed by a gaming device. The method also includes receiving, in the gaming device, the pre-recorded media segment and presenting the pre-recorded media segment.

### RELATED APPLICATION

This application claims the benefit of U.S. Provisional Application Ser. No. 60/657,731 filed May 3, 2004, which is incorporated herein by reference.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to the field of gaming devices and more particularly to presenting media in a gaming device.

### BACKGROUND

As gaming devices continue to evolve, they continue to provide new and entertaining ways for presenting gaming content. Gaming devices often employ various rendering techniques for rendering gaming content. Rendering techniques are mathematical modeling techniques for converting high-level object-based descriptions (e.g., an outline drawing) into fully formed three-dimensional images. These rendering techniques can include ray tracing, volume rendering, and surface rendering. In some prior art gaming devices, rendered images are used for presenting game results and/or for entertaining players. For example, in some slot machines, the slot machine reels are often represented by rendered images.

One disadvantage of presenting gaming results using rendered images is that players often associate rendered images with children's video games. When players make such an association, they may avoid the gaming device; thus causing reduced popularity and revenues. Another disadvantage of using rendered images in a gaming device is that rendering techniques call for relatively specialized rendering hardware/software, which can be expensive to develop and/or integrate into gaming systems.

### SUMMARY

A method and apparatus for presenting media in a gaming device are described herein. In one embodiment, the method includes selecting a pre-recorded media segment from a set of pre-recorded media segments, wherein the selecting is performed by a gaming device. The method also includes receiving, in the gaming device, the pre-recorded media segment and presenting the pre-recorded media segment.

In one embodiment the system includes a media storage and playback device to store a set of one or more pre-recorded media segments. In the embodiment, the system also includes a gaming device communicatively coupled to the media storage device, the gaming device including a gaming control unit to receive ones of the set of one or more pre-recorded media segments, an audio presentation unit to present certain of the ones, a video presentation unit to present certain of the ones; and an input unit to receive user input.

### BRIEF DESCRIPTION OF THE FIGURES

The present invention is illustrated by way of example and not limitation in the Figures of the accompanying drawings in which:

FIG. 1 illustrates an exemplary gaming system used in conjunction with certain embodiments of the invention;

FIG. 2 is a block diagram illustrating a gaming system, according to exemplary embodiments of the invention;

FIG. 3 is a block diagram illustrating details of a media storage and playback device, according to exemplary embodiments of the invention;

FIG. 4 is a flow diagram illustrating a method performed by a gaming device for requesting and presenting a pre-recorded media segment, according to exemplary embodiments of the invention;

FIG. 5 is a flow diagram illustrating operations performed by a media storage and playback device for receiving a request for and transmitting a pre-recorded media segment, according to exemplary embodiments of the invention;

FIG. 6 is a data structure illustrating a dynamic path graph of pre-recorded media segments, according to exemplary embodiments of the invention; and

FIG. 7 is a flow diagram illustrating a method performed by a gaming device for presenting pre-recorded media segments in response to user input, according to exemplary embodiments of the invention.

### DESCRIPTION OF THE EMBODIMENTS

Methods and apparatus for presenting media in a gaming device are described herein. In the following description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams will be described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Moreover, it should be understood that although the flow diagrams depict serial operations, certain embodiments could perform certain of those operations in parallel or in a different order.

This description of the embodiments is divided into four sections. In the first section, an exemplary hardware and operating environment is described. In the second section, a system level overview is presented. In the third section, methods for using exemplary embodiments are described. In the fourth section, an exemplary implementation is described.

### System Level Overview

This section provides an overview of an exemplary system for presenting media on a gaming device. Additional details of the exemplary system will be described below, in the following sections.

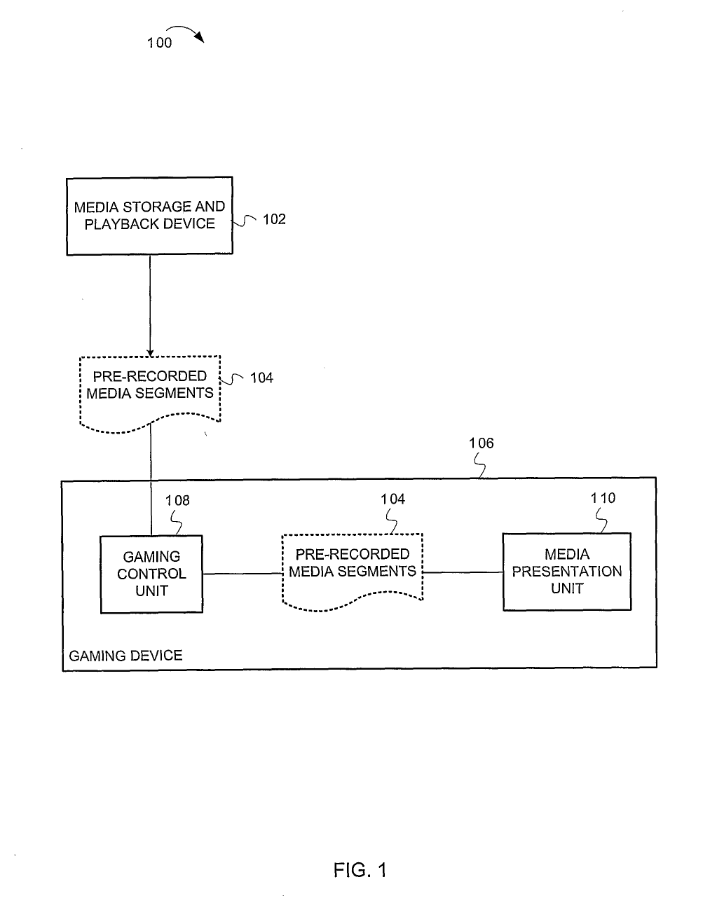

FIG. 1 is a data flow diagram illustrating operations and data flow for presenting pre-recorded media on a gaming device, according to exemplary embodiments of the invention. As illustrated in FIG. 1, the gaming system 100 comprises a media storage and playback device 102, which can be a DVD player. The gaming system 100 also includes a gaming device 106, which includes a gaming control unit 108 and a media presentation unit 110. The media presentation unit 110 can include audio speakers and a video monitor.

The gaming system 100 conducts casino games such as video poker, video black jack, and slots. During the course of a game, the gaming system 100 indicates a game state or game result by presenting pre-recorded media segments 104. For example, in a video slot machine game, the gaming control unit 108 selects a set of reel symbols (i.e., game results) that will be presented to a player. Based on the selected reel symbols, the gaming control unit 102 receives a set of one or more pre-recorded media segments 104 from the media storage and playback device 102. The pre-recorded media segments 104 can include pre-recorded audio and video footage of a spin of mechanical reels. The gaming device 106 indicates the game results by presenting the pre-recorded footage on the media presentation unit 110. As another example, in a video poker game, after the gaming control unit 102 selects a player's initial cards, it presents pre-recorded media segments 104 that include audio and video footage of a dealer dealing the player's initial cards. The video footage can be a video camera recording of a person dealing the player's initial cards.

The gaming system 100 presents the pre-recorded media segments 104 without employing any rendering techniques. That is, the gaming system 100 does not convert high-level object-based descriptions (e.g., an outline drawing) into fully formed three-dimensional images. However, the gaming system 100 does present pre-recorded media segments stored in DVD-Video or similar formats (e.g., DivX, DVD-RAM, DVD-RW, DVD+RW, and DVD+R, and DVD-R).

### Hardware and Operating Environment

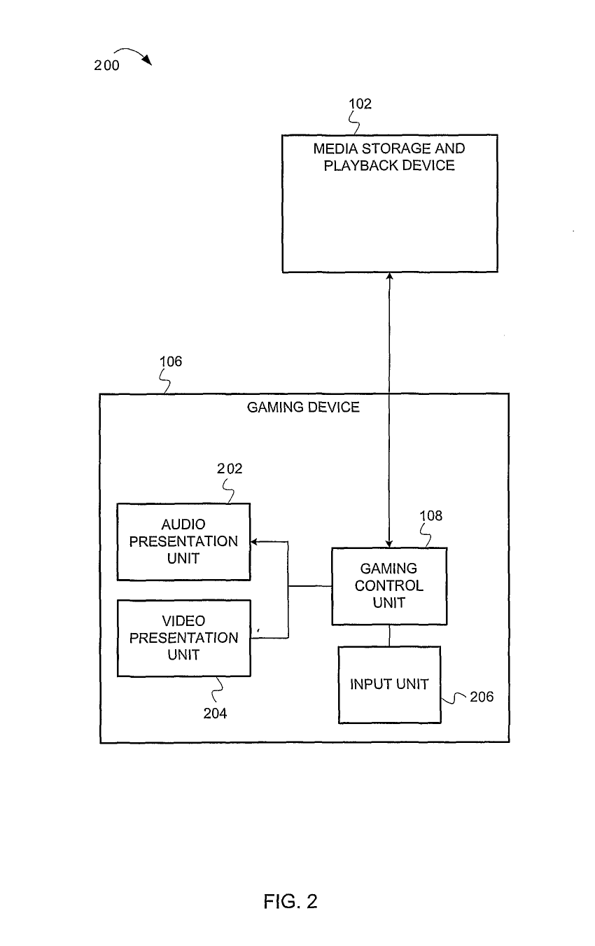

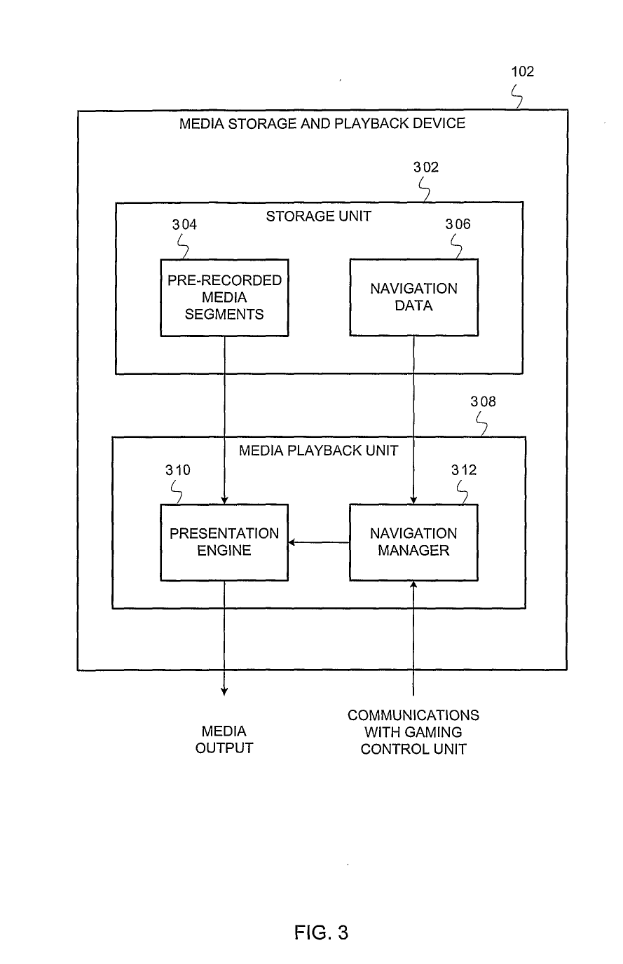

This section provides a system level overview of exemplary embodiments of the invention. In particular, this section provides a system architecture, according to exemplary embodiments of the invention. FIGS. 2 and 3 show system components for presenting pre-recorded media in a gaming device. Operations of the system components of FIGS. 2 and 3 are described in the following sections.

FIG. 2 is a block diagram illustrating a more detailed view of a gaming system, according to exemplary embodiments of the invention. As shown in FIG. 2, the gaming system 200 includes a media storage and playback device 102 and a gaming device 106. The media storage and playback device 102 stores, plays back, and/or transmits pre-recorded media segments. The media storage and playback device 102 can be a DVD player (including a DVD-ROM), CD player (including a CD-ROM), Digital Video Recorder (DVR) (including a hard disk drive), or other suitable means for storing and playing back media.

The gaming device 106 includes an audio presentation unit 202 and a video presentation unit 204. The audio presentation unit 202 presents audio contained within the pre-recorded media segments, while the video presentation unit 204 displays video content contained within the pre-recorded media segments. The audio presentation unit 202 can include one or more audio speakers or other suitable audio playback device. The audio presentation unit 202 can present any suitable type of audio content. The video presentation unit 204 can include one or more cathode ray tubes (CRTs), liquid crystal displays (LCDs), plasma displays, and projection displays. The video presentation unit can present motion pictures, still pictures, text, or other suitable images.

The gaming device 106 also includes an input unit 206 and a gaming control unit 108. The input unit 206 includes sensors, buttons, switches, ports, and/or other suitable devices for receiving input from players and external devices. The gaming control unit 108 includes hardware and/or software for conducting a game. According to embodiments, the gaming control unit 108 can include one or more random number generators, processors, and/or other logic for conducting games.

FIG. 3 is a block diagram illustrating a more detailed view of a media storage and playback device, according to exemplary embodiments of the invention. As shown in FIG. 3, the media storage and playback device 102 includes a storage unit 302 and a playback unit 308. The storage unit 302 includes pre-recorded media segments 304 and navigation data 306. The media playback unit 308 includes a presentation engine 310 and a navigation manager 312.

In one embodiment, the media storage and playback device 102 is a DVD-Video player (or software DVD-Video navigator). Alternatively, the media storage and playback device 102 can include a DVR, CD player, VHS player, or any suitable media playback device.

The navigation manager 312 receives requests for pre-recorded media segments from the gaming control unit 108. The navigation manager 312 also receives navigation data 306 from the storage unit 312. The navigation manager 312 uses the navigation data 306 to create graphical user interface menus used by the gaming control unit 108 and to facilitate control branching between media segments. The navigation manager 312 also uses the navigation data to determine physical addresses of the requested pre-recorded media segments. The navigation manager 312 transmits the addresses to the presentation engine 310. The presentation engine 310 receives the address information and fetches the requested pre-recorded media segments. The presentation engine 310 can include a media decoder, such as DVD-video decoder, and MPEG decoder. for decoding the pre-recorded media segments.

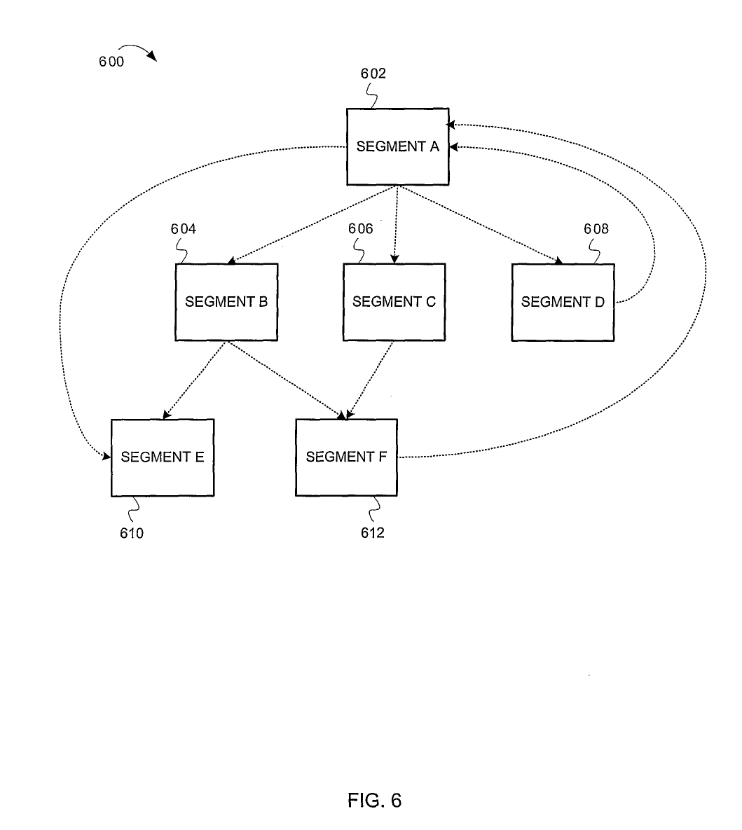

The pre-recorded media segments 304 can be organized in any suitable fashion. Techniques for organizing the pre-recorded media segments are described below (see discussion of FIG. 6). The pre-recorded media segments 304 can include pre-recorded footage captured by a video camera and audio recorder. Alternatively, the pre-recorded media segments 304 can be pre-recorded animation sequences that are rendered during the recording process, but presented without performing rendering. The pre-recorded media segments 304 can include titling (i.e., text), which is shown when the pre-recorded media segment is presented. The pre-recorded media segments can also include titling in combination with other video content (e.g., titling and motion pictures).

The pre-recorded media segments 304 can also include keyed footage. In keyed footage, a subject is recorded in front of a monochromatic background. The monochromatic background is then replaced with an artificially created background scene. For example, a game show host is filmed with a “blue screen” background. The blue screen is then replaced with a game show set, forming the keyed video footage.

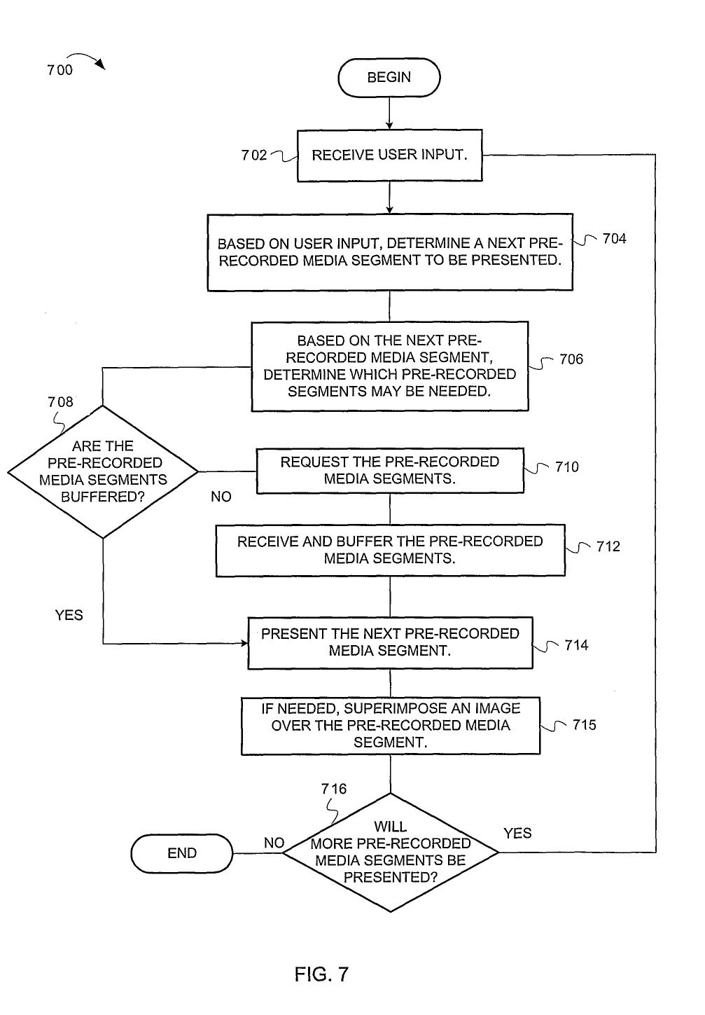

The navigation data 306 can include information and a command set that allows the gaming control unit 108 to interact with the media storage and playback device 102. The navigation data 306 can also include information for presenting menus and providing content selection and feature control. The navigation data can also include search data for creating navigational structures that can be traversed by program control (see discussion of FIGS. 7-8).

According to embodiments of the invention, the functional units of the gaming system 200 (e.g., the gaming device 106 and the media gaming control unit 108) can be integrated or divided, forming a lesser or greater number of functional units. According to embodiments, the functional units can include queues, stacks, or other data structures necessary for performing the functionality described herein. Moreover, the functional units can be communicatively coupled using any suitable communication method (e.g., message passing, parameter passing, signals). Additionally, the functional units can be connected according to any suitable interconnection architecture (e.g., fully connected, hypercube). Any of the functional units used in conjunction with embodiments of the invention can include machine-readable media for performing operations described herein. Machine-readable media includes any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other forms of propagated signals (e.g., carrier waves, infrared signals, digital signals). According to embodiments of the invention, the functional units can be other types of logic (e.g., digital logic) for executing the operations for presenting pre-recorded media segments in a gaming machine described herein.

### Exemplary System Operations

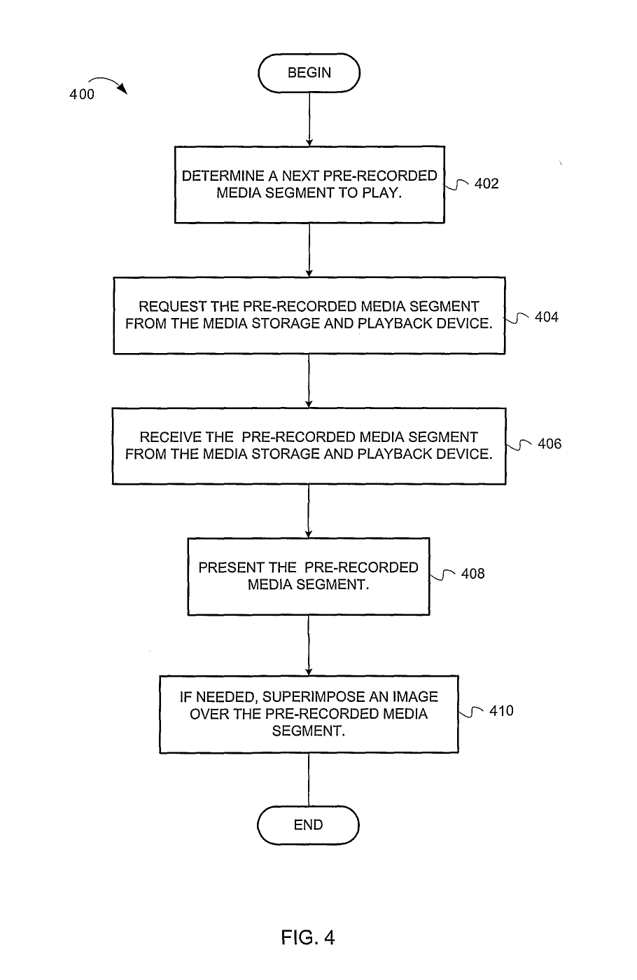

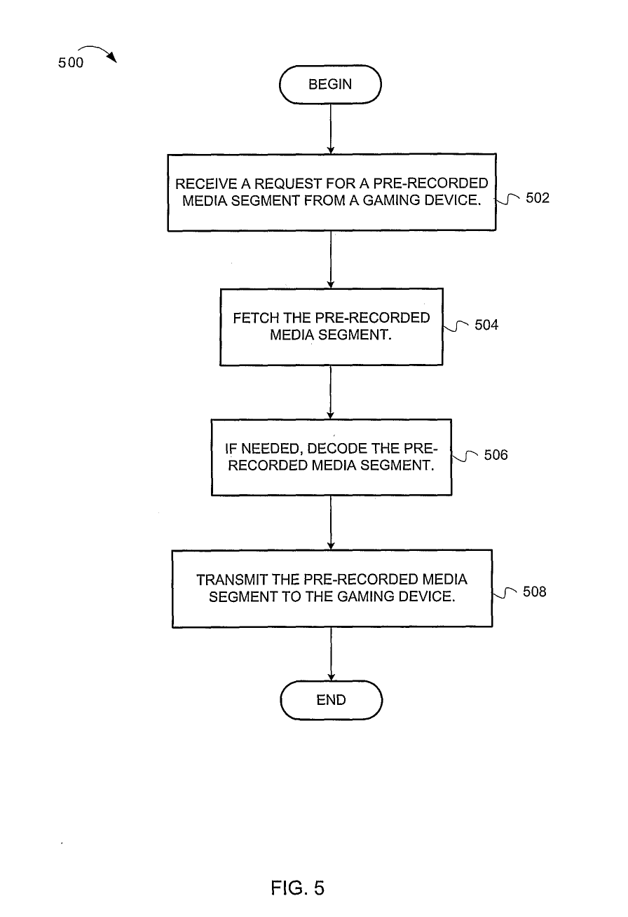

This section describes operations performed by embodiments of the invention. In certain embodiments, the operations are performed by instructions stored on a machine-readable media (e.g., software), while in other embodiments the operations are performed by hardware or other logic (e.g., digital logic). In this section, FIGS. 4-7 will be discussed. In particular, FIGS. 4 and 5 describe operations for requesting, fetching, and presenting a pre-recorded media segment, while FIG. 6-8 describe operations for dynamically branching between and presenting pre-recorded media segments.

FIG. 4 is a flow diagram illustrating operations for requesting and presenting a pre-recorded media segment, according to exemplary embodiments of the invention. The operations of the flow diagram 400 will be described with reference to the exemplary embodiments shown in FIGS. 2 and 3. The flow diagram 400 commences at block 402.

At block 402, a next pre-recorded media segment is selected for presentation. For example, the gaming control unit 108 selects a next pre-recorded media segment for presentation. In one embodiment, the gaming control unit 108 selects a pre-recorded media segment based on gaming results that it has calculated. For example, the gaming control unit 108 can select the next pre-recorded media segment based on results from a random number generator or other functional unit used for determining game results/states. The flow continues at block 404.

At block 404, the next pre-recorded media segment is requested from the media storage and playback device. For example, the gaming control unit 108 requests the next pre-recorded media segment from the media storage and playback device 102. The media request can include a logical identifier that uniquely identifies a particular pre-recorded media segment. The logical identifier can be used to locate (e.g., determine a physical address of) the requested pre-recorded media segment within the storage unit 302. In one embodiment, the gaming control unit 108 transmits the media request over a bus (not shown), while other embodiments call for other suitable transmission techniques. The flow continues at block 406.

At block 406, the pre-recorded media segment is received from the media storage and playback device. For example, the gaming control unit 108 receives the next pre-recorded media segment from the media storage and playback device 102. In one embodiment, the gaming control unit 108 receives the next pre-recorded media segment over a bus and stores it in a buffer. The flow continues at block 408.

As shown in block 408, the next prerecorded media segment is presented. For example, the gaming control unit 108 transmits the next pre-recorded media segment to the audio presentation unit 202 and/or the video presentation unit 204. In one embodiment, the gaming control unit 108 transmits audio portions of the pre-recorded media segment to the audio presentation unit 202, while transmitting video portions to the video presentation unit 204. The audio and video presentation units present the pre-recorded media segment. From block 408, the flow continues at block 410.

At block 410, an image is superimposed over the pre-recorded media segment, if necessary. For example, the gaming control unit 108 superimposes an image over the pre-recorded media segment, if necessary. The gaming control unit 108 could superimpose a card face (e.g., the two of Diamonds, Jack of Spades) on a pre-recorded media segment in which a dealer flips faceless cards. As the pre-recorded media segment shows the dealer flipping the faceless card, the gaming control unit 108 superimposes a card face image over the faceless card, giving the impression that the pre-recorded card has a face. In instances where there is no image to superimpose, the gaming control unit 108 does not superimpose an image on the pre-recorded media segment. From block 410, the flow ends.

FIG. 5 is a flow diagram illustrating operations for receiving a media request and transmitting a pre-recorded media segment, according to exemplary embodiments of the invention. The operations of the flow diagram 500 will be described with reference to the exemplary embodiments shown in FIGS. 2 and 3. The flow diagram 500 begins at block 502.

At block 502, a request for a pre-recorded media segment is received from a gaming device. For example, the navigation manager 312 receives a request for a prerecorded media segment from the gaming device 106. As noted above, the media request identifies a media segment stored in the storage unit 302. In one embodiment, the media request includes a logical reference to the prerecorded media segment. However, the media request can include a physical address. The flow continues at block 504.

At block 504, the pre-recorded media segment is fetched. For example, in fetching the pre-recorded media segment, the navigation manager 312 determines a physical address at which the prerecorded media segment is stored in the storage unit 302. The navigation manager 312 transmits the physical address to the presentation engine 310. Based on the physical address, the presentation engine 310 fetches the prerecorded media segment from the storage unit 302. In an alternative embodiment, the navigation manager 312 does not determine the physical address of the prerecorded media segment, as the physical address can be included within the media request. The flow continues at block 506.

At block 506, the pre-recorded media segment is decoded, if necessary. For example, if necessary, the presentation engine 310 decodes the prerecorded media segment. As noted above, in certain embodiments, the pre-recorded media segment is encoded according to a video format (e.g., DVD-video, MPEG). If the pre-recorded media segment is encoded, the presentation engine 310 decodes the encoded pre-recorded media segment. From block 506, the flow continues at block 508.

At block 508, the pre-recorded media segment is transmitted to the gaming device. For example, the presentation engine 310 transmits the prerecorded media segment to the gaming control unit 108. From block 508, the flow ends.

While FIGS. 4 and 5 describe operations for requesting, fetching, and presenting a pre-recorded media segment, FIGS. 6-7 describe data structures and operations for dynamically selecting and presenting pre-recorded media segments.

FIG. 6 is a data structure illustrating a dynamic path graph of pre-recorded media segments, according to exemplary embodiments of the invention.

The dynamic path graph 600 represents an order for presenting pre-recorded media segments. Based on the order, the gaming system can present several “versions” of the same “media clip.” Moreover, the gaming system 200 can use dynamic path graphs to dynamically select pre-recorded media segments during a game (i.e., at runtime).

The set of prerecorded media segment includes segments A-F (illustrated as blocks 602, 604, 606, 608, 610, 612, respectively), which are connected by set of directed edges (i.e. arrows). According to the dynamic path graph 600, segment A (602) is the first prerecorded media segment that can be presented. After segment A is presented, either segment B, segment C, or segment D can be presented. Depending on which segment is selected, the graph can be traversed to either segment B, segment C, or segment D. The dynamic path graph 600 can be continuously traversed until an end state is encountered (i.e., there is no directed edge progressing to another segment).

The gaming system 200 can select a segment based on player input, a random selection, or a predetermined display sequence. When the segment selection is based on user input, a segment is selected in response to player input received by the input unit 206. For example, if the input unit 206 includes several buttons, segment A will be selected if a first button is actuated, segment B will be selected if a second button is actuated, and so on. When segment selections are predetermined, the gaming system 200 can show multiple versions of a media clip. For example, in one version, the media clip can consist of segments A, B, and F, while another version consists of segments A, C, and F. Different versions can be used for showing similar footage from different camera angles. For example, one version can be from a first person view, while another version can be from a third person perspective.

According to embodiments, the gaming system 200 can include dynamic path graphs of any size and complexity. That is, the gaming system 200 can include dynamic path graphs that include any number of segments and directed edges. According to embodiments, the gaming control unit 108 includes one or more dynamic path graphs. Alternatively, other components can include one or more dynamic path graphs.

FIG. 7 is a flow diagram illustrating operations for dynamically selecting pre-recorded media segments in response to user input, according to exemplary embodiments of the invention. The operations of the flow diagram 700 will be described with reference to the exemplary embodiments shown in FIGS. 2, 3, and 6. The flow diagram 700 begins at block 702.

At block 702, user input is received. For example, the input unit 206 receives input from a player. According to embodiments, the input can be received when the player actuates buttons, switches, a joystick, or other suitable input device included in the input unit 206. From block 702, the flow continues at block 704.

At block 704, based on user input, a next pre-recorded media segment is selected for presentation. For example, the gaming control unit 108 selects a next pre-recorded media segment, based on the user input. In one embodiment, the gaming control unit 108 uses a dynamic path graph to select a next pre-recorded media segment. If the current pre-recorded media segment is segment A (see FIG. 6), the gaming control unit 108 selects between segments B, C, and D based on the user input. From block 704, the flow continues at block 706.

At block 706, based on the next pre-recorded media segment, needed pre-recorded media segments are selected. For example, based on the pre-recorded media segment selected at block 704, the gaming control unit 108 determines which prerecorded media segments may be needed. In the dynamic path graph 600, if the next pre-recorded media segment is segment B, segments E and F will be needed, as one of them will be presented after segment B. The flow continues at block 708

At block 708, it is determined whether the pre-recorded media segments are buffered. For example, the gaming control unit 108 determines whether any of the soon needed prerecorded media segments are stored in its buffered. If the pre-recorded media segments are buffered, the flow continues at block 714. Otherwise, the flow continues at block 710.

At block 710, the pre-recorded media segments are requested. For example, the gaming control unit 108 requests the pre-recorded media segments from the media storage and playback device 102. From block 710, the flow continues at block 712.

At block 712, the pre-recorded media segments are received and buffered. For example, the gaming control unit 108 receives the pre-recorded media segments from the media storage and playback device 102 and stores them in a buffer. From block 712, the flow continues at block 714.

At block 714, the next pre-recorded media segment is presented. For example, the gaming control unit 108 presents the next pre-recorded media segment. From block 714, the flow continues at block 716.

At block 715, an image is superimposed over the pre-recorded media segment, if necessary. For example, the gaming control unit 108 superimposes an image over the pre-recorded media segment, if necessary. The gaming control unit 108 could superimpose a card face (e.g., the two of Diamonds, Jack of Spades) on a pre-recorded media segment in which a dealer flips faceless cards, as described above. The flow continues at block 715.

At block 716, it is determined whether more pre-recorded media segments will be presented. For example the gaming control unit 108 determines whether more pre-recorded media segments will be presented. If more pre-recorded media segments will be presented, the flow continues at block 702. Otherwise, the flow ends.

Thus, a method and apparatus for presenting media in a gaming device have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method comprising:
selecting a pre-recorded media segment from a set of pre-recorded media segments, wherein the selecting is performed by a gaming device;
receiving, in the gaming device, the pre-recorded media segment; and
presenting the pre-recorded media segment.

2. The method of claim 1 further comprising:
superimposing an image over the presented pre-recorded media segment.

3. The method of claim 1, wherein the pre-recorded media segment includes text, audio content, or video content.

4. The method of claim 1, wherein the selecting is based on a game result.

5. The method of claim 1, wherein the pre-recorded media segment represents a game result.

6. The method of claim 1, wherein the presenting does not include rendering the pre-recorded media segment.

7. The method of claim 1, wherein the pre-recorded media segment includes video content recorded by a video camera.

8. A system comprising:
a media storage and playback device to store a set of one or more pre-recorded media segments;
a gaming device communicatively coupled to the media storage device, the gaming device including,
a gaming control unit to receive ones of the set of one or more pre-recorded media segments;
an audio presentation unit to present certain of the ones;
a video presentation unit to present certain of the ones; and
an input unit to receive user input.

9. The system of claim 8, wherein the media storage and playback device comprises:
a navigation manager to determine a location of a requested pre-recorded media segment; and
a presentation engine to transmit the requested pre-recorded media segment to the gaming device.

10. The system of claim 8, wherein the one or more pre-recorded media segments include audio content, video content, or text.

11. The system of claim 8, wherein the pre-recorded media segments represent game results.

12. An apparatus comprising:
an input device to receive user input;
a gaming control unit to receive the user input, wherein the gaming control unit includes a media control unit to select pre-recorded media segments based on the user input;
an audio presentation unit to present at least one of the pre-recorded media segments; and
a video presentation unit to present at least one of the pre-recorded media segments.

13. The apparatus of claim 12, wherein the pre-recorded media segments include audio content, video content, or text.

14. The method of claim 12, wherein the pre-recorded media segments include video content recorded by a video camera.

15. The apparatus of claim 12, wherein the audio presentation unit does not perform rendering to present the pre-recorded media segments.

16. A machine-readable medium that provides instructions, which when executed by a machine, cause the machine to perform operations comprising:
receiving a first user input in a gaming device;
selecting, based on the first user input, a first pre-recorded media segment;
selecting, based on the first pre-recorded media segment, a second pre-recorded media segment;
requesting the first and second pre-recorded media segments from a media storage and playback device;
receiving the first and second pre-recorded media segments from the media storage device;
presenting the first pre-recorded media segment;
receiving a second user input; and
presenting, in response to the second user input, the second pre-recorded media segment.

17. The machine-readable medium of claim 16, wherein the presenting the first pre-recorded media segment does not include rendering.

18. The machine-readable medium of claim 16, further comprising:
superimposing an image over the presented pre-recorded media segment.

19. The machine-readable medium of 16, wherein the media storage and playback device is selected from the set consisting of a DVD-ROM, hard disk, CD-ROM, and flash memory device.

20. The machine-readable medium of claim 16, wherein the pre-recorded media segment includes audio content, video content, or text.

21. A computer program embedded in a computer-readable medium comprising computer program code means adapted to perform all the steps of claim 1 when said program is run on a computer.
